(19) United States
(12) Patent Application Publication
(10) Pub. No.: US 2025/0091475 A1
(43) Pub. Date: Mar. 20, 2025

(54) CONTROL DEVICE

(71) Applicant: TOYOTA JIDOSHA KABUSHIKI KAISHA, TOYOTA-SHI (JP)

(72) Inventors: Akinori MORISHIMA, Kanagawa-ken (JP); Tateki HANASHIMA, Nagoya-shi (JP)

(73) Assignee: TOYOTA JIDOSHA KABUSHIKI KAISHA, TOYOTA-SHI (JP)

(21) Appl. No.: 18/631,266

(22) Filed: Apr. 10, 2024

(30) Foreign Application Priority Data
Sep. 19, 2023 (JP) 2023-151469

(51) Int. Cl. B60L 58/12; B60L 53/51; B60L 53/52; B60L 53/62; B60L 58/16

(52) U.S. Cl. CPC B60L 58/12; B60L 53/51; B60L 53/52; B60L 53/62; B60L 58/16

(57) ABSTRACT

A control device for controlling a vehicle, wherein the vehicle includes a power storage device and a power converter. The power converter is configured to be capable of charging the power storage device using electric power from the outside of the vehicle, and discharging electric power from the power storage device to the outside of the vehicle. The control device includes a CPU and a memory that stores a process executed by the processor. CPU controls the power supply device so that the target SOC set by the user of the vehicle is reached at the scheduled departure time. CPU causes the power supply device to perform at least one of charge/discharge in a range higher than the lower limit SOC when the vehicle does not depart even after the scheduled departure time has elapsed.

### CROSS-REFERENCE TO RELATED APPLICATION

This application claims priority to Japanese Patent Application No. 2023-151469 filed on Sep. 19, 2023, incorporated herein by reference in its entirety.

### BACKGROUND

### 1. Technical Field

The present disclosure relates to a control device.

### 2. Description of Related Art

Japanese Unexamined Patent Application Publication No. 2021-177697 (JP 2021-177697 A) describes a vehicle including a power storage device and configured to be capable of charging the power storage device with electric power supplied from a power stand. Further, the above vehicle can perform timer charging in which a scheduled departure time is set and charging is completed by the scheduled departure time.

### SUMMARY

In recent years, it has been studied to effectively utilize surplus electric power in a facility such as a house, by charging an in-vehicle power storage device in a time period in which power generation of renewable energy power generation peaks. In addition, it also has been studied to compensate for power consumption in a facility such as a house with electric power in a power storage device of a vehicle when the vehicle is connected to a power stand.

On the other hand, when the above vehicle is connected to a power stand even after the scheduled departure time, charging and discharging with the power stand cannot be performed.

Therefore, there arises an issue that the power storage device of the vehicle cannot be charged with surplus electric power in a facility such as a house in a state in which the vehicle is connected to the power stand after the scheduled departure time. In addition, there arises an issue that electric power in the power storage device of the vehicle cannot be supplied to a facility such as a house in a state in which the vehicle is connected to the power stand after the scheduled departure time.

The present disclosure has been made in view of the above issues. An object of the present disclosure is to provide a control device that controls a vehicle such that at least one of charging and discharging can be performed with an external facility or the like when the vehicle is connected to a power stand after a scheduled departure time.

An aspect of the present disclosure provides a control device that controls a vehicle, in which:
the vehicle includes a power storage device and a power supply device;
the power supply device is configured to allow at least one of charging of the power storage device using electric power from an outside of the vehicle and discharging of electric power from the power storage device to the outside of the vehicle;
the control device includes a processor and a memory that stores a process to be executed by the processor;
the processor controls the power supply device such that a target state of charge (SOC) set by a user of the vehicle is reached at a scheduled departure time; and
the processor causes the power supply device to perform at least one of charging and discharging in a range higher than a lower limit SOC set by the user of the vehicle when the vehicle has not departed at the scheduled departure time.

With the control device according to the present disclosure, it is possible to perform at least one of charging and discharging with an external facility or the like when a vehicle is connected to a power stand after a scheduled departure time.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically illustrating an overall configuration of a power system including a vehicle according to Embodiment 1;

FIG. 2 is a diagram illustrating an exemplary SOC usable range and a temporal transition of SOC;

FIG. 3 is a flowchart executed by ECU 15, the power stand 20, the electric power facility 30, the server 70, and the user terminal 80;

FIG. 4 is a flow diagram showing a continuation of the flow shown in FIG. 3; and

FIG. 5 is a flowchart for explaining in detail how to select a command related to power utilization control in S17.

### DETAILED DESCRIPTION OF EMBODIMENTS

Embodiments of the present disclosure will be described with reference to the drawings. In the drawings referred to below, the same or corresponding members are given the same numbers.

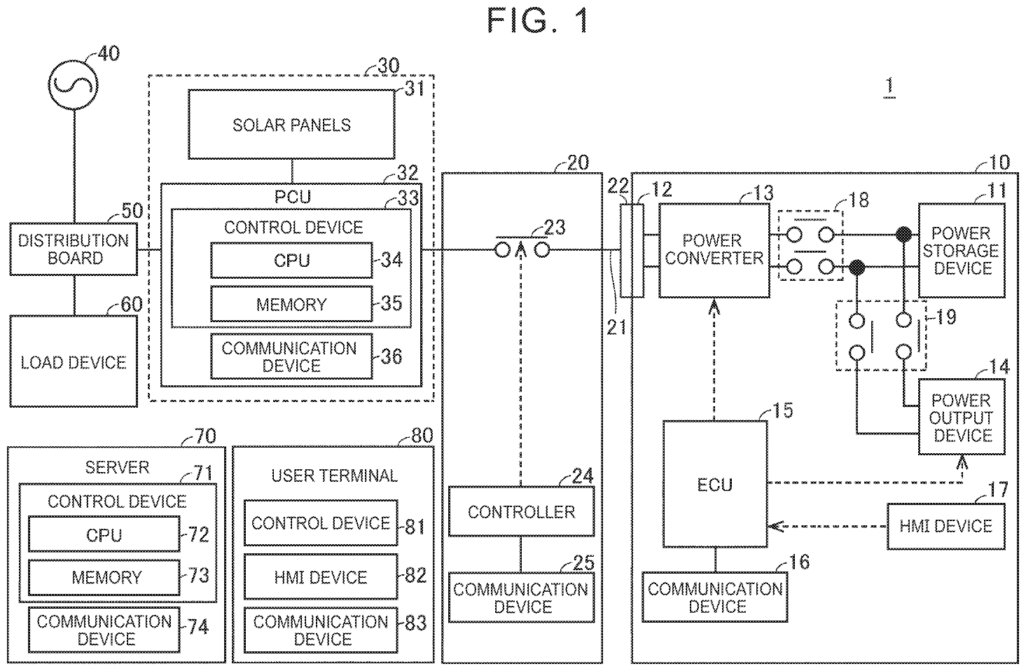

FIG. 1 is a diagram schematically illustrating an overall configuration of a power system including a vehicle according to a first embodiment. The power system 1 includes a vehicle 10, a power stand 20, an electric power facility 30, a system power supply 40, a distribution board 50, a load device 60, a server 70, and a user terminal 80.

The vehicle 10 and the power stand 20 are formed to be electrically connectable by a charging cable. The vehicle 10 is a vehicle of a certain user as long as it is formed so as to be capable of plug-in charging, and includes, for example, a hybrid electric vehicle, a battery electric vehicle, and the like.

The vehicle 10 includes a power storage device 11, a connector 12, a power converter 13, a power output device 14, a Home Energy Management System (ECU) 15, a communication device 16, a Human Machine Interface (HMI) device 17, a charging relay 18, and a System Main Relay (SMR) 19.

Both units 10 can charge the power storage device 11 using the electric power supplied from the power stand 20. The vehicle 10 is also capable of discharging the power of the power storage device 11 to the power stand 20.

The power storage device 11 is a chargeable and dischargeable secondary battery. The connector 12 is connectable to a connector 22 provided at a distal end of the power cable 21 of the power stand 20.

The power converter 13 is a power supply device controlled by a control signal from ECU 15. The power converter 13 converts the electric power supplied from the power stand 20 into electric power that can be charged by the power storage device 11, and supplies the electric power to the power storage device 11, thereby charging the power storage device 11. Further, the power converter 13 converts the electric power discharged from the power storage device 11 into electric power that can be received by the power stand 20, and supplies the electric power to the power stand 20. The power converter 13 includes, for example, bi-directional AC/DC converters.

The power output device 14 generates the driving force of the vehicle 10 by using the electric power stored in the power storage device 11. Specifically, the power output device 14 generates the driving force of the vehicle 10 based on the drive command signal from ECU 15, and outputs the generated driving force to the driving wheels of the vehicle 10. In addition, the power output device 14 discharges when receiving a power generation command signal from ECU 15, and supplies the electric power to the power storage device 11.

The vehicle 10 includes a plurality of sensors that detect various physical quantities necessary for controlling the vehicle 10, such as a monitoring sensor that detects a state (voltage, current, temperature, and the like) of the power storage device 11. The sensors are configured to transmit the detected data to ECU 15. In addition, the vehicle 10 accumulates data of the electric power rate of the electric power charged in the power storage device 11. The stored data is outputted to ECU 15. With this data, the price of the electric power stored in the power storage device 11 is calculated.

ECU 15 includes a Central Processing Unit (CPU) (not shown), a memory (Read Only Memory (ROM), a Random Access Memory (RAM), and the like), and controls each device of the vehicle 10 based on information recorded in the memory and information from each sensor. ECU 15 wirelessly or wirelessly communicates with the communication device 25, 74, and 83 provided in the electric power stand 20, the electric power facility 30, the server 70, and the user terminal 80 outside the vehicles through the communication device 16.

The communication device 16 is an interface for communicating with devices (the power stand 20, the electric power facility 30, the server 70, the user terminal 80, and the like) outside the vehicle. The communication device 16 transmits the information transmitted from ECU 15 to the device outside the vehicle, and transmits the information received from the device outside the vehicle to ECU 15.

HMI device 17 is a device that provides various types of data to the user of the vehicle 10 and accepts the user's manipulation of the vehicle 10. HMI device 17 includes a display including a touch panel, a speaker, and the like.

The power stand 20 is a facility for the vehicle 10 to perform charging and discharging. The power stand 20 includes a power cable 21, a connector 22, a relay 23, a controller 24, and a communication device 25. The power stand 20 is electrically connected to the distribution board 50 via a PCU 32.

One end of the power cable 21 is connected to the relay 23, and the other end is provided with a connector 22. When power is supplied to the vehicle 10 and power is received from the vehicle 10, the connector 22 of the power cable 21 is connected to the connector 12 of the vehicle 10, and the relay 23 is closed. The opening and closing operation of the relay 23 is controlled by the controller 24.

The electric power facility 30 includes a solar panel 31 and a PCU 32. The solar panel 31 is a power generation facility that generates electric energy by the energy of sunlight. The solar panel 31 is electrically connected to PCU 32. The solar panel 31 receives sunlight, generates a direct current, and supplies the generated direct current to PCU 32.

PCU 32 includes various electric quantity converting devices (not shown), a control device, and a communication device 36. The control device includes a CPU 34 and memories 35. PCU 32 converts the direct current supplied from the solar panel 31 into an alternating current, rectifies the voltage and frequency of the power storage device 11 and the power, and supplies the converted direct current to the power storage device 11, the system power supply 40, and the load device 60 via the power stand 20 and the distribution board 50. Alternatively, PCU 32 adjusts the frequency/voltage of the power of the power storage device 11 supplied via the power stand 20 and supplies the frequency/voltage to the system power supply 40. The communication device 36 is configured to communicate with the communication device 16 of the vehicle 10 wirelessly or wirelessly.

The system power supply 40 is a commercial power supply supplied from an electric power company. The system power supply 40 supplies power to the power storage device 11 and the load device 60 via the distribution board 50. The distribution board 50 converts the voltage of the electric power supplied from the system power supply 40 into a low voltage so that the load device 60 or the like can use the voltage.

The load device 60 is an arbitrary electric device that operates by receiving the amount of electricity from the distribution board 50. The load device 60 is, for example, a household electric appliance or a commercial manufacturing facility.

The server 70 is formed of a control device 71 and a communication device 74. The control device 71 includes a CPU 72, a memory 73, and an input/output port for inputting and outputting various signals. Various kinds of control executed by the control device 71 are executed by a software process, that is, a program stored in the memory 73 is read by CPU 72. Various kinds of control by the control device 71 are not limited to software processing, and may be processed by dedicated hardware (electronic circuit).

The communication device 74 of the server 70 can wirelessly communicate with the communication device 16 of the vehicle 10, for example. The communication device 74 can acquire information such as weather information and a power rate via a communication network such as the Internet. Note that information such as a power rate is provided from a server of a management company that manages the system power supply 40.

Further, the server 70 stores, in the memory 73, charge/discharge history information indicating the past charge/discharge time of the vehicle 10 and the electricity rate at the time of the past charge/discharge.

The user terminal 80 is a communication terminal that can be carried by a user of the vehicle 10, for example, a smartphone. The user terminal 80 includes a control device 81, a HMI device 82, and a communication device 83.

The control device 81 includes a CPU and memories (not shown). The control device 81 controls HMI device 82 and the communication device 83 of the user terminal 80 based on information stored in the memory, content inputted to HMI device 82 of the user terminal 80, and the like. HMI device 82 is a device that provides various data to a user and accepts a user's manipulation. The communication device 83 can wirelessly communicate with the communication device 16 of the vehicle 10. Various functions of the power system 1 formed as described above will be described.

The in-vehicle power storage device can perform power utilization control. Note that the power utilization control includes at least one of charging the power storage device with surplus power such as a solar panel, supplying the power of the power storage device to the load device, and adjusting the power supply-demand balance.

The user of the vehicle permits the power utilization control of the power storage device in a time period in which the vehicle is not used, for example, before the departure time of the vehicle. The timer charge control is a control in which State of charge (SOC) of the power storage device 11 becomes the target SOC at the scheduled departure time. In the timer charging, in order to suppress a situation in which SOC of the power storage device of the vehicle has decreased at the time of departure, the vehicle is charged so that the power storage device reaches the target SOC at the scheduled departure time. The target SOC may be a value set by the user or a value set by defaults. Further, the scheduled departure time may be a time arbitrarily set by the user, or may be a time estimated from the use result of the vehicle.

On the other hand, it is expected that the user will not use the vehicle even at the scheduled departure time. In this case, since the target SOC is maintained at the set departure time even after the scheduled departure time has elapsed, the vehicle may not effectively utilize the electric power in the power storage device.

Therefore, the vehicle 10 according to the first embodiment has a configuration for suppressing the occurrence of the above-described situation. Specifically, the vehicle 10 includes a power converter 13 for enabling the power storage device 11 to charge and discharge. When the power converter 13 is connected to the power stand 20 through the power cable 21, the vehicle 10 performs the power utilization control within a SOC usable area arbitrarily set by the user of the power storage device 11. SOC usable range is composed of the lower limit SOC and the upper limit SOC. The lower limit SOC is equal to or less than the target SOC, and the upper limit SOC is set to be larger than the target SOC.

ECU 15 of the vehicle 10 instructs the power stand 20 through the communication devices 16, 25 so that power utilization control can be performed within SOC usable range. The power stand 20 opens and closes the relay 23 in accordance with a control instruction of ECU 15.

With such a configuration, even if a situation occurs in which the user is not using the vehicle 10 after the scheduled departure time t10 of the vehicle 10 has elapsed, the power utilization control can be performed within SOC usable range by using the power storage device 11.

The target SOC, the upper limit SOC, and the lower limit SOC are defaulted to ECU 15. Note that the user of the vehicle 10 may set in advance by the user terminal 80. The value set in the user terminal 80 through HMI device 82 is reflected in ECU 15 by the communication between the communication device 83 and the communication device 16.

In the above embodiment, the power system 1 includes the electric power facility 30 and the distribution board 50, but the present disclosure is not limited thereto. For example, the power system 1 may have the function of Home Energy Management Service (HEMS). Specifically, the power of the system power supply 40 is supplied to the load device 60 through a distribution board corresponding to HEMS via the smart meter. The electric power facility 30 includes HEMS controllers. HEMS controllers are configured to communicate with a distribution board corresponding to a HEMS, a load device 60, and a PCU 32. Accordingly, HEMS controllers can acquire the data of the electric devices and control the operation of the load device 60.

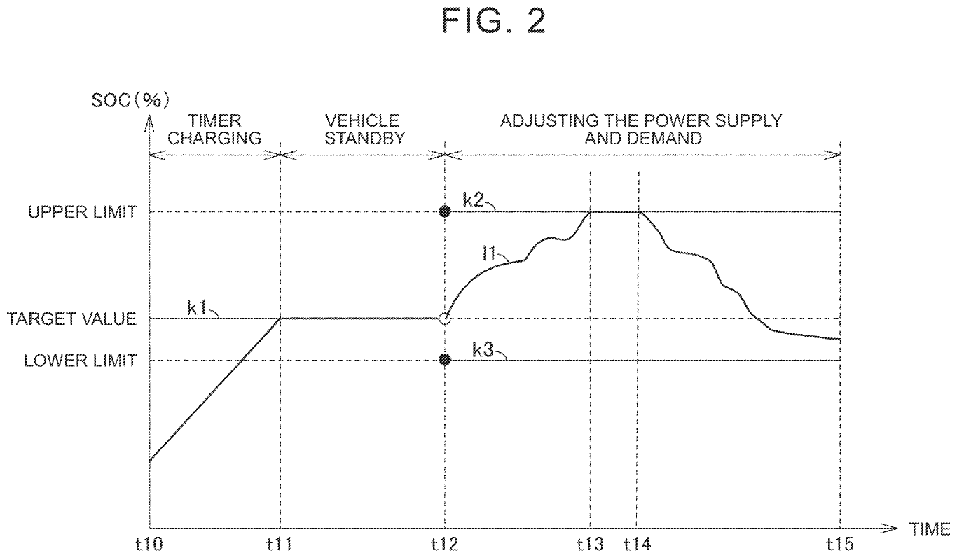

FIG. 2 is a diagram illustrating an exemplary temporal transition of a SOC usable range and a SOC. The line k1 indicates a target SOC. The line k2 indicates the upper limit SOC of SOC usable range, and the line k3 indicates the lower limit SOC of SOC usable range. In the present embodiment, the target SOC, the upper limit SOC, and the lower limit SOC are, for example, 60%, 90%, and 40%. The line L1 shows the time-course of the actual SOC. Referring to FIG. 2, the temporal transition of the line L1 will be described.

The time t11 from the time t10 indicates a time period of the timer charge. The time t11 is a scheduled departure time of the vehicle 10. The vehicle 10 are charged so that SOC of the power storage device 11 reaches the target SOC at the time t11.

The time t12 from the time t11 indicates the waiting time of the vehicles. The lower limit SOC of the vehicle 10 stands by while maintaining the target SOC until the time t12 elapses. Note that, during the standby period, power for maintaining the activation status of ECU 15 or the like is required. Therefore, by setting the standby period to, for example, about 15 minutes, it is possible to suppress the power consumed by ECU 15 being excessively large.

The time t15 from the time t12 indicates a time period in which the vehicle 10 performs the power utilization control. Specifically, in the time period from the time t12 to the time t13, surplus power is generated by the solar-panel power generation, and the power storage device 11 is charged via the power stand 20. Thereafter, when SOC reaches the upper limit SOC of the line k2, the power supply from the power stand 20 to the vehicle 10 is stopped until the time t14. In a time period from the time t14 to the time t15, the power storage device 11 supplies power to the system power supply 40 and the load device 60 via the power stand 20. In the time t15, the user of the vehicle 10 starts using the vehicle 10. The electric connection between the vehicle 10 and the electric power stand 20 is released by the use of the vehicle 10, and the electric power utilization control of the vehicle 10 ends.

The standby time of the vehicle 10 is set in advance by the user terminal 80 by the user of the vehicle 10. Specifically, the value set in the user terminal 80 through HMI device 82 is reflected in ECU 15 by the communication between the communication device 83 and the communication device 16. Note that the standby period may or may not be set to ECU 15 by defaults.

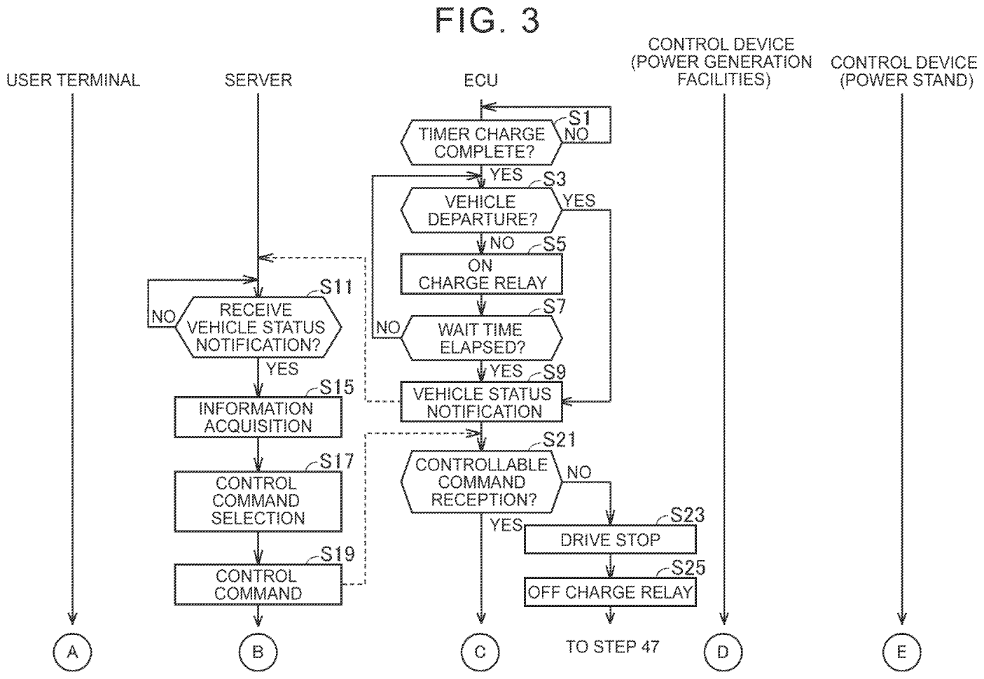

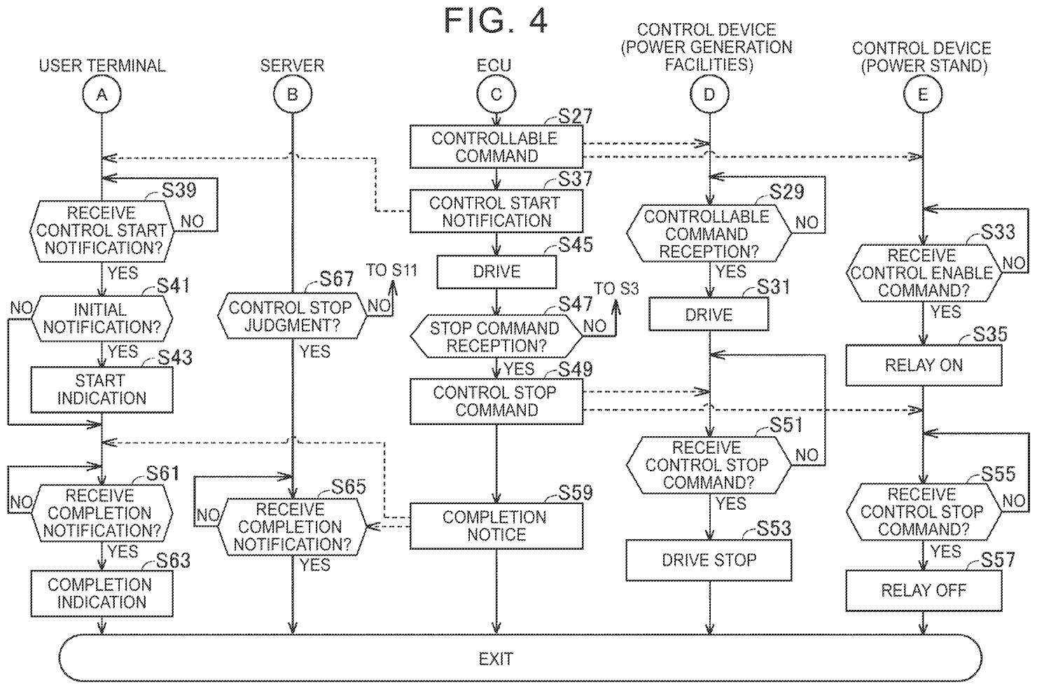

FIG. 3 is a flowchart executed by ECU 15, the power stand 20, the electric power facility 30, the server 70, and the user terminal 80. FIG. 4 is a flow diagram illustrating a continuation of the flow illustrated in FIG. 3.

In S1, ECU 15 determines whether the timer charge is complete. Specifically, in the present embodiment, it is determined whether or not the scheduled departure time has elapsed.

If the scheduled departure time has not elapsed (No in S1), S1 process is repeated. If the scheduled departure time has elapsed (YES in S1), it is determined in S3 whether or not the vehicle 10 has departed.

If the vehicle 10 is starting (YES in S3), the process proceeds to step-9. On the other hand, if the vehicle 10 is not departing, ECU 15 maintains the charging relay 18 ON in S5.

In S7, ECU 15 determines whether or not the vehicle 10 has passed a predetermined waiting period. The waiting time is a fixed period starting from the scheduled departure time. The predetermined duration may be arbitrarily set by the user through HMI device 82 of the user terminal 80. Further, in the past timer charging, the server 70 may set a predetermined period based on a difference between the scheduled departure time and the actual result of the time when the vehicle 10 actually departs. If the wait period has not elapsed (No in S7), the flow returns to S3 and ECU 15 repeats the process again. On the other hand, when the waiting period has elapsed (Yes in S7), in S9, ECU 15 transmits a vehicle status notification of the vehicle 10 to the server 70. The vehicle status notification includes information on whether or not the vehicle 10 starts and information indicating SOC of the current power storage device 11. In addition, the vehicle state notification may include information indicating a charge/discharge start time.

In S11, the server 70 determines whether or not to receive the vehicle-state notification. If the server 70 has not received the vehicle-status notification from ECU 15 (No in S11), S11 is repeated. If the server 70 has received a vehicle-status notification from ECU 15 (YES in S11), the flow transitions to S15.

In S15, the server 70 acquires data via the communication device 74. The information includes weather information in the area where the solar panel 31 is installed.

In S17, the server 70 selects commands related to the power utilization control. As the command, any one of a controllable command (charge), a controllable command (discharge), a control stop command, and a control stop command is selected.

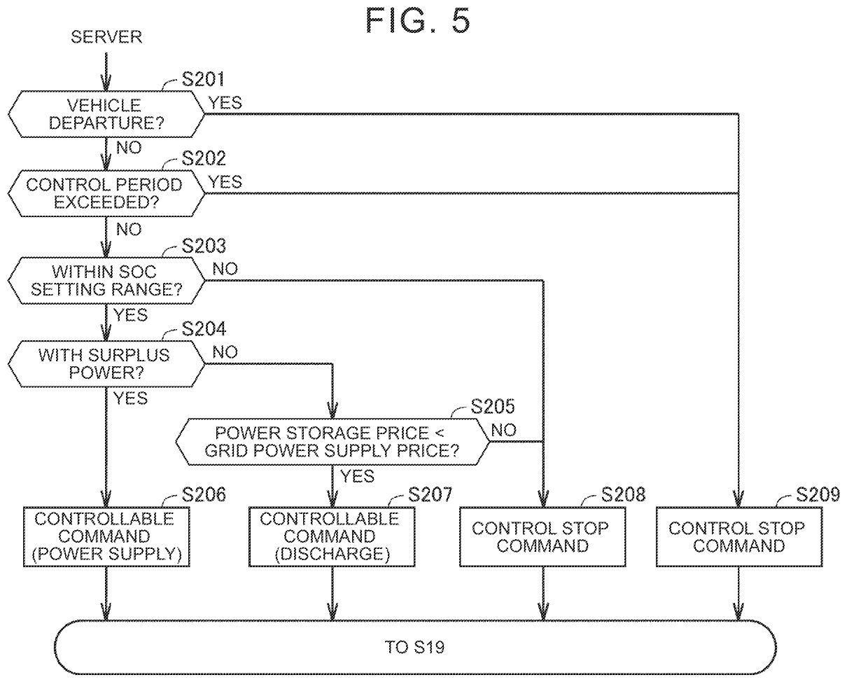

FIG. 5 is a flowchart for explaining in detail how to select a command related to power utilization control in S17.

In S201, the server 70 determines whether the vehicles are departing. The determination is based on the information included in the vehicle-status notification received from ECU 15 in S11. When the server 70 determines that the vehicle is departing (Yes in S201), the server 70 selects a control stopping command in S209. When the server 70 determines that the vehicle has not departed (No in S201), the flow-through proceeds to S202.

In S202, the server 70 determines whether or not the control duration has been exceeded. Note that the control period is a predetermined period starting from the start of control, and power utilization control is performed during this period. The predetermined period is set in advance in the server. In addition, the user may set it arbitrarily in advance.

When the server 70 determines that the control period is exceeded (No in S202), the server 70 selects a control stopping command in S209. When the server 70 determines that the control period has not been exceeded (No in S202), the process proceeds to S203.

In S203, the server 70 determines whether or not SOC status of the current power storage device 11 is within SOC setting range. The determination is based on the information included in the vehicle-status notification received from ECU 15 in S11. When the server 70 determines that SOC status of the power storage device 11 is not within SOC setting range (No in S203), the server 70 selects the control stop command in S208. When the server 70 determines that SOC status of the power storage device 11 is within SOC setting range (Yes in S203), the process proceeds to S204.

In S204, the server 70 determines whether or not there is excess power in the electric power facility 30. This determination is based on the information obtained in S15. Specifically, in the present embodiment, when the sunrise time is sunrise time and the weather is fine from the weather information, calendar, and time of the area where the solar panel 31 is installed, the server 70 determines that there is surplus power.

When the server 70 determines that there is surplus power (Yes in S204), the server 70 selects a controllable command (charge) in S206. When the server 70 determines that there is no surplus power (No in S204), the process proceeds to S205.

In S205, the server 70 determines whether the price of the electric power supplied from the system power supply 40 is higher than the price of the electric power stored in the power storage device 11. When the server 70 determines that the price of electric power supplied from the system power supply 40 is higher than the price of electric power stored in the power storage device 11, the server 70 determines that S207 is a controllable command (discharging). When the server 70 determines that the power price supplied from the system power supply 40 is not higher than the power price stored in the power storage device 11, the server 70 selects the control stop command in S208.

Referring back to FIG. 3, an example of the process is shown. In S19, the server 70 transmits the control command selected by the server 70 in S17 to ECU 15.

In S21, ECU 15 determines whether the control command received from the server 70 in S19 is a controllable command. If it is determined that ECU 15 is not a controllable command, the process proceeds to S23.

In S23, ECU 15 deactivates the driving of the power utilization control, and in S25, ECU 15 turns OFF the charging relay 18. If the power utilization control is already stopped, the state is maintained. Specifically, ECU 15 deactivates the control of the power output device 14 and turns OFF the charging relay 18. The flow then transitions to S47.

In S27, ECU 15 sends control commands to the communication device 25, 36 of the electric power facility 30 and the power stand 20. The controllable command transmitted by ECU 15 includes either charge or discharge.

In S29, the electric power facility 30 determines whether or not a controllable command has been received from ECU 15. If no controllable command has been received (No in $29), S29 process is repeated. When the controllable command is received (Yes in S29), the electric power facility 30 performs driving in accordance with the power utilization control in S31.

Specifically, when the controllable command received by S29 includes charge information, the electric power facility 30 drives the power storage device 11 to charge. Specifically, CPU 34 of the electric power facility 30 controls PCU 32 so as to provide the electric power generated by the solar panel 31 to the power storage device 11.

When the controllable command received by S29 includes discharge data, the electric power facility 30 drives the power storage device 11 to discharge. Specifically, CPU 34 of the electric power facility 30 controls PCU 32 so that the electric power discharged by the power storage device 11 is supplied to the distribution board 50.

In S33, the power stand 20 determines whether a controllable command has been received from ECU 15. If no controllable command has been received (No in S33), S33 process is repeated. When a controllable command is received (Yes in S33), in S33, the power stand 20 turns ON the relay 23. In the above-described control, the same control is performed regardless of charging and discharging.

In S37, ECU 15 sends a control initiation notification to the user terminal 80. In S39, the user terminal 80 determines whether a control initiation notification has been received from ECU 15. When the control starting notification is not received (No in S39), the user terminal 80 repeats S39 process. When a control initiation notification is received (Yes in S39), the process proceeds to S41.

In S41, the user terminal 80 determines whether or not the control starting notification received in S39 is the first time. If the control initiation notification is not the first time (No in S41), the process proceeds to S61. When the control start notification is the first time (Yes in S41), in S43, the user terminal 80 notifies the user of the vehicle 10 that the vehicle 10 has started the power utilization control by HMI device 82.

In S45, ECU 15 is driven by power utilization control. Specifically, when the control command received by S21 includes charge information, the power output device 14 is controlled, and charging of the power storage device 11 is started through the power stand 20 by surplus power of the solar panel 31. On the other hand, when the control command received by S21 includes discharge data, the power output device 14 is controlled to discharge the power of the power storage device 11 and to be supplied to the electric power facility 30.

In S47, ECU 15 determines whether the control command transmitted by the server 70 to ECU 15 in S19 is a control stopping command. When ECU 15 has not received the control stopping command (No in S47), the process proceeds to S3. When ECU 15 has received the control stopping command (Yes in S47), the process proceeds to S49. In S49, ECU 15 sends a control shutdown command to the electric power facility 30 and the power stand 20.

In S51, the electric power facility 30 determines whether or not a control stopping command has been received from ECU 15. When the electric power facility 30 has not received the control stopping command (No in S51), the electric power facility 30 repeats S51 process. When the electric power facility 30 receives the control stop command (Yes in S51), in S53, the electric power facility 30 stops driving accompanying the power utilization control in accordance with the control stop command of CPU 34, and the control process ends.

In S55, the power stand 20 determines whether or not a control stopping command has been received from ECU 15. When the power stand 20 has not received the control stopping command (No in S55), the power stand 20 repeats S55 process. When the power stand 20 receives the control stopping command (Yes in S55), in S57, the controller 24 turns OFF the relay 23, and the control process ends.

In S59, ECU 15 provides a completion notification to the user terminal 80 and the server 70. Note that the completion notification may include information indicating the charge/discharge end time.

In S61, the user terminal 80 determines whether or not a completion notification from ECU 15 has been received. When the completion notification is not received from the user terminal 80 (No in S61), the user terminal 80 repeats S61 process. When the completion notification is received from the user terminal 80 (Yes in S61), in S63, the user terminal 80 notifies the user of the vehicle 10 of the completion of the power utilization control by HMI device 82, and the control process of the user terminal 80 ends.

In S65, the server 70 determines whether a completion notification from ECU 15 has been received. When the completion notification is not received from the server 70 (No in S65), the server 70 repeats S65 process. When the completion notification is received from the server 70 (Yes in S65), the control process of the server 70 ends.

As described above, in the present embodiment, ECU 15 determines that the vehicle 10 has not departed even after the completion of the timer charging, and notifies the server 70 of the vehicle status after a predetermined waiting time has elapsed. The server 70 that has received the vehicle-state selects the control command of the power utilization control based on the weather information acquired by the communication device 74, and instructs ECU 15 to perform the power utilization control. Accordingly, it is possible to prevent the charging and discharging of the power storage device 11 from being restricted until the user starts the vehicle 10 after the timer charging.

In the above embodiment, the power utilization control is performed within SOC setting range. However, the present disclosure is not limited to this. For example, the power output device 14 may be controlled to charge and discharge in a range higher than the lower limit SOC set by the user of the vehicle 10.

In the above embodiment, the power storage device 11 performs charging and discharging by the power utilization control, but the present disclosure is not limited thereto. For example, at least one of charging of the power storage device 11 and discharging from the power storage device 11 may be formed to be possible.

In the above embodiment, an example in which the server 70 performs the power utilization control has been described, but the present disclosure is not limited thereto. For example, ECU 15 may determine whether or not to perform the power utilization control by receiving weather information or the like through the communication device 16 of the vehicle 10.

In the above embodiment, the necessity of the power utilization control command is determined by the weather information acquired by the server 70, but the present disclosure is not limited to this. For example, the server 70 may be determined based on a power rate provided by a management company that manages the system power supply 40. Specifically, the server 70 acquires, from ECU 15, the electric power charge of the electric power stored in the power storage device 11. When the electric power charge of the power storage device 11 is lower than the electric power charge provided by the management company that manages the system power supply 40, the server 70 sends an electric power utilization control command to ECU 15, and ECU 15 discharges the electric power storage device 11 and supplies the electric power to the load device 60 connected to the electric power facility 30.

In the above embodiment, in the power utilization control, the charging of the power storage device 11 is started by the surplus power of the solar panel 31 included in the electric power facility 30, but the present disclosure is not limited to this. For example, the electric power facility 30 may include a power generation device capable of generating electric power using renewable energy and supplying electric power to the load device 60. Renewable energy is wind, geothermal, hydroelectric, biomass, etc.

In the above embodiment, the server 70 determines that there is surplus power based on the weather information acquired by the server 70, and issues a power utilization control command to ECU 15. For example, ECU 15 may determine the presence or absence of surplus power by acquiring data from HEMS. Note that the information from HEMS includes the power generation amount of the solar panel 31, the power consumption amount of the load device 60, the power amount supplied from the system power supply 40, the power rate of the power supplied from the system power supply 40, the selling price of the power generated by the solar panel 31, and the like. Further, the surplus power in this case is the power that becomes surplus even when the power generated by the solar panel 31 is supplied to the load device 60.

In the above-described embodiment, in the above-described S202, the server 70 determines that the power utilization control is to be stopped when the vehicles start, but when the power utilization control is to be stopped, various conditions can be adopted.

For example, it is conceivable that the number of times of operation of the charging relay 18 becomes equal to or more than a predetermined number of times, the degree of deterioration indicating the deterioration state of the power storage device 11 becomes equal to or more than a predetermined value, and the cumulative charge/discharge time of charge and discharge of the power converter 13 becomes equal to or more than a predetermined value. When at least one of the above conditions is satisfied, it may be determined that the power utilization control is to be stopped.

A case where the power utilization control is not performed when the number of operations of the charging relay 18 becomes equal to or more than a predetermined number of times will be described. ECU 15 stores data indicating the number of operations of the charging relay 18. In the above-described S9, the vehicle-state notification includes information indicating the number of times of operation of the charging relay 18. When the server 70 determines that the number of operations of the charging relay 18 is equal to or greater than a predetermined value, it determines that the power utilization control is stopped.

A case where the power utilization control is not performed when the deterioration degree indicating the deterioration state of the power storage device 11 becomes equal to or higher than a predetermined value will be described. ECU 15 calculates a deterioration degree indicating a deterioration condition of the power storage device 11, and stores information indicating a deterioration degree of the power storage device 11. The vehicle-state notification in S9 includes information indicating the degree of degradation of the power storage device 11. Then, the server 70 determines to stop the power utilization control when it is determined that the degree of deterioration indicating the deterioration state of the power storage device 11 is equal to or greater than a predetermined value.

A case where the power utilization control is stopped when the integrated charge/discharge time of charging and discharging of the power converter 13 becomes equal to or more than a predetermined value will be described. ECU 15 stores data indicating cumulative charge/discharge times of charge and discharge of the power converter 13. The vehicle-state notification in S9 includes information indicating an integrated charge/discharge time of charge and discharge of the power converter 13. Then, the server 70 determines to stop the power utilization control when it is determined that the accumulated charge/discharge time for charging and discharging the power converter 13 is equal to or more than a predetermined value.

It should be considered that the embodiments disclosed above are for illustrative purposes only and are not limitative of the disclosure in any aspect. The scope of the present disclosure is defined by the terms of the claims, and is intended to include any modifications within the scope and meaning equivalent to the terms of the claims.

What is claimed is:

1. A control device that controls a vehicle, wherein:
the vehicle includes a power storage device and a power supply device;
the power supply device is configured to allow at least one of charging of the power storage device using electric power from an outside of the vehicle and discharging of electric power from the power storage device to the outside of the vehicle;
the control device includes a processor and a memory that stores a process to be executed by the processor;
the processor controls the power supply device such that a target state of charge (SOC) set by a user of the vehicle is reached at a scheduled departure time; and
the processor causes the power supply device to perform at least one of charging and discharging in a range higher than a lower limit SOC set by the user of the vehicle when the vehicle has not departed at the scheduled departure time.

2. The control device according to claim 1, wherein:
the power supply device is configured to allow at least one of charging of the power storage device using electric power from an electric power facility provided outside the vehicle, and discharging of electric power from the power storage device to the electric power facility;
the electric power facility is connected to a facility that includes at least one electric power load; and
when an electric power rate of electric power consumed by the electric power load is higher than an electric power rate of the electric power charged in the power storage device, the processor causes the power supply device to discharge electric power from the power storage device to the electric power facility.

3. The control device according to claim 1, wherein:
an electric power facility includes a power generation device that is able to generate electric power using renewable energy and that supplies electric power to an electric power load; and
the control device causes the power supply device to charge the power storage device when it is determined that surplus power is generated in the power generation device.

4. The control device according to claim 1, wherein:
the vehicle further includes a relay provided in an electric circuit between the power supply device and the power storage device; and
the processor turns on the relay at the scheduled departure time.

5. The control device according to claim 4, wherein the processor does not perform power utilization control in any of the following cases:
when a number of times of operation of the relay becomes equal to or greater than a predetermined number of times;
when a degree of deterioration that indicates a state of deterioration of the power storage device becomes equal to or greater than a predetermined value; and
when an integrated charge-discharge time of charging and discharging of the power supply device becomes equal to or greater than a predetermined value.
